(19) United States
(12) Patent Application Publication
(10) Pub. No.: US 2021/0279810 A1
(43) Pub. Date: Sep. 9, 2021

(54) INTERACTIVE AND ADAPTIVE SYSTEMS AND METHODS FOR INSURANCE APPLICATION

(71) Applicant: Jenny Life, Inc., Seattle, WA (US)

(72) Inventors: Chirag Pancholi, Seattle, WA (US); Lief Larson, Seattle, WA (US)

(21) Appl. No.: 17/155,480

(22) Filed: Jan. 22, 2021

Related U.S. Application Data
(63) Continuation of application No. 15/986,331, filed on May 22, 2018, now abandoned.
(60) Provisional application No. 62/510,639, filed on May 24, 2017.

(51) Int. Cl. G06Q 40/08; G06F 3/0482

(52) U.S. Cl. CPC G06Q 40/08; G06F 3/0482

(57) ABSTRACT

The disclosure relates to interactive and adaptive systems and methods for insurance application. Depending on how the application process is tailored and/or adapted to individual applicants' identity, location, status, health condition, medical history, or other information collected during the process, the application process can provide UIs in different form, content, sequence, and/or quantity, to different applicants as part or the entirety of the insurance application process.

### CROSS-REFERENCE TO RELATED APPLICATION(S)

This application is a continuation of U.S. patent application Ser. No. 15/986,331, filed on May 22, 2018, entitled INTERACTIVE AND ADAPTIVE SYSTEMS AND METHODS FOR INSURANCE APPLICATION, which claims the benefit of U.S. Provisional Application No. 62/510,639, filed on May 24, 2017, entitled SYSTEMS AND METHODS FOR INSURANCE APPLICATION AND VALIDATION-ACCELERATED UNDERWRITING, which is incorporated herein by reference in its entirety.

### TECHNICAL FIELD

The disclosed technology relates generally to systems and methods for insurance applications, and in particular to systems, methods, and software applications for mobile devices for an insurance application process.

### BACKGROUND

One of the most difficult challenges in consumers obtaining insurance is that the application process can be arduous, take many weeks, and in some cases even requires blood testing. Applying for insurance (e.g., life insurance) typically involves many rigid steps as the insurance company needs to carefully collect, inspect and weigh application information to decide whether an applicant is a good risk and price it according. This process typically involves the collection of highly detailed personally identifiable information (PII), such as name, phone number, address, date of birth, DNA, and other information, which is often collected via one or more detailed, standard application forms and/or interviews. In addition, applicants are often required to coordinate a visit by a para-med to collect the submitted blood/urine samples, and capture general medical vitals as part of the application and determination process. These long, rigid, and often complicated insurance application processes can leave the consumer frustrated and underinsured for long periods of time. These high friction, multi-touchpoint, drawn-out processes can limit insurance sales because of applicant abandonment. Additionally, applicants can be exposed to unprotected mortality risk because they sometimes delay or stop the application process due to fatigue and frustration.

### SUMMARY

In some embodiments, a computer-implemented method is performed by a portable computing device that is configured to communicate with at least one remote computing device. The method includes presenting a first set of user interfaces for an application for insurance, receiving image data from a user in response to the user's interaction with the first set of user interfaces, identifying personally identifiable information based, at least in part, on the received image data, and transmitting the personally identifiable information to the at least one remote computing device, wherein the personally identifiable information is analyzed based, at least in part, on communication between the remote computing device and one or more third-party computing resources. The method can further include receiving instructions from the at least one remote computing device for generating a second set of user interfaces based, at least in part, on the analysis of the personally identifiable information, generating and presenting the second set of user interfaces, and receiving additional data from the user in response to the user's interaction with the second set of user interfaces. Still further, the method can include, concurrently with presenting the second set of user interfaces, transmitting at least a portion of the additional data to the at least one remote computing device, wherein the at least a portion of the additional data is analyzed based, at least in part, on communication between the remote computing device and one or more third-party computing resources, and providing a result for the application for insurance based, at least in part, on the analysis of the at least a portion of the additional data.

In some embodiments, is completed in a period of time equal to or shorter than 10 minutes, 9 minutes, 8 minutes, 7 minutes, 6 minutes, 5 minutes, 4 minutes, or another suitable period of time. In some embodiments, the first set of user interfaces are predefined independent of the personally identifiable information of the user. In some embodiments, the image data includes at least one of an image of an identification card, an image of a payment card, or an image of the user's face.

In some embodiments, the method is completed without need for the user to manually type or key in textual information. In some embodiments, the method further includes receiving instructions from the at least one remote computing device for generating a third set of user interfaces based, at least in part, on the analysis of the at least a portion of the additional data. In some embodiments, providing a result for the application for insurance is further based on the user's interaction with the third set of user interfaces.

In some embodiments, a non-transitory computer-readable medium stores content that, when executed by one or more processors, causes the one or more processors to perform actions including: receiving image data from a user in response to the user's interaction with a first set of user interfaces for an insurance application, identifying user-specific information based, at least in part, on the received image data, and transmitting the user-specific information to the at least one remote computing device for analysis. In some embodiments, the actions further include receiving from the at least one remote computing device a first response to the transmitted user-specific information, presenting a second set of user interfaces based, at least in part, on the first response, and receiving additional data from the user in response to the user's interaction with the second set of user interfaces. In some embodiments, the actions further include, concurrently with presenting the second set of user interfaces, transmitting at least a portion of the additional data to the at least one remote computing device for analysis, and providing a result for the insurance application based, at least in part, on a second response to the transmitted at least a portion of the additional data.

In some embodiments, the second set of user interfaces are dynamically generated responsive to receiving the first response. In some embodiments, content for the second set of user interfaces is generated, at least in part, by the at least one remote computing device. In some embodiments, the actions further comprise causing matching a first image of the user's face with a second image data of the user's face. In some embodiments, the first image is derived from an image of an identification card and the second image includes the user's face captured live by a mobile device. In some embodiments, the image data includes the first image and the additional data includes the second image.

In some embodiments, the actions further comprise presenting a third set of user interfaces based, at least in part, on the second response. In some embodiments, the result of the insurance application includes at least one of approval, denial, or notice for further processing.

In some embodiments, a system includes at least a memory storing computer-executable instructions, and one or more processors that, when executing the instructions, are configured to: receive image data from a user, identify personally identifiable information based, at least in part, on the received image data, cause first analysis of the personally identifiable information, and present one or more user interfaces based, at least in part, on the first analysis. In some embodiments, the one or more processors are further configured to: receive additional data from the user via the one or more user interfaces, concurrently with presenting the one or more user interfaces, cause second analysis of at least a portion of the additional data and/or the personally identifiable information, and determine a result for insurance application based, at least in part, on the second analysis.

In some embodiments, the system corresponds to a mobile phone or a server computer. In some embodiments, the one or more processors are further configured to validate the identified personally identifiable information. In some embodiments, the one or more processors are further configured to verify the user's identity based, at least in part, on the personally identifiable information. In some embodiments, the one or more processors are further configured to evaluate fraud risks based on the personally identifiable information. In some embodiments, the one or more processors are further configured to automatically underwrite an insurance policy for the user based, at least in part, on data associated with the user.

At least some embodiments of the technology are systems and methods for insurance policy underwriting based on accelerated validation. The systems and methods can provide applicants with an insurance policy application process that includes application completion, review, acceptance, and/or policy underwriting within a short period of time. The systems and methods can reduce the consumer inputs and efforts required to apply for and to receive an insurance policy. Accordingly, the systems and methods can minimize or limit consumer frustration, consumer abandonment, and/or consumer mortality risks.

In some embodiments, a system is configured to allow applicants to rapidly complete an application process by employing automated, rapid, and synchronous steps. For example, a mobile device can be used to obtain information for the application process to avoid, limit, or minimize manually inputted information. In some applications, the mobile device can capture one or more images or videos of objects, such as passports, documents (e.g., birth certificates, social security cards, etc.), driver's license, or other objects with personally identifiable information, to obtain most or all of the information for the application process.

In some embodiments, a user can use a smart phone to complete an insurance application without manually inputting a significant amount of data. The smart phone can capture image data and can automatically complete one or more steps based on the image data. In further embodiments, a system comprises a server computer, mobile phone, or other computing device programmed to receive image data associated with a user, identify personally identifiable information based on the received image data, analyze the personally identifiable information, and/or underwrite insurance based on the personally identifiable information.

### BRIEF DESCRIPTION OF THE DRAWINGS

FIG. 1 is a block diagram of a system for implementing a mobile insurance application in accordance with some embodiments of the disclosed technology;

FIG. 2A illustrates a process for an applicant to apply for insurance (e.g., life insurance).

FIG. 2B illustrates an example process for applying for insurance in accordance with some embodiments of the disclosed technology.

FIG. 3 is a flow diagram of steps performed by an insurance system in accordance with some embodiments of the disclosed technology.

FIG. 4 is a flow chart for optical character recognition (OCR) technology used with a driver's license and credit card/debit card in accordance with some embodiments of the disclosed technology.

FIGS. 5-9 illustrate at least part of an insurance application process in accordance with some embodiments of the disclosed technology.

FIG. 10 is a flow chart for preventing fraud, lead scoring, evaluating credit risk, and enhancing PII information in accordance with some embodiments of the disclosed technology.

FIG. 11 is a flow chart of an example process for an interactive insurance application in accordance with some embodiments of the presently disclosed technology.

### DETAILED DESCRIPTION

The following description provides specific details for a thorough understanding and enabling description of these examples. One skilled in the relevant art will understand, however, that embodiments of the invention may be practiced without many of these details. Likewise, one skilled in the relevant art will also understand that embodiments incorporate many other obvious features not described in detail herein. Additionally, some steps, well-known structures, or functions may not be shown or described in detail below, to avoid unnecessarily obscuring the relevant description.

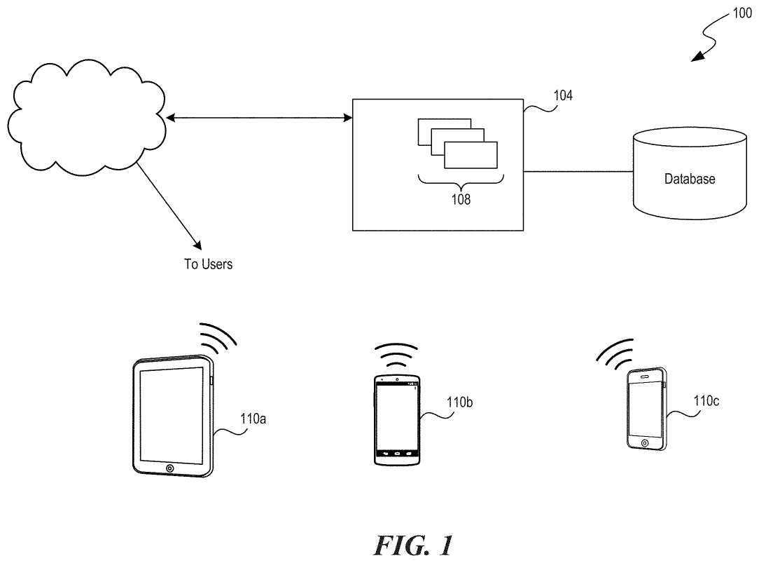

FIG. 1 illustrates a representative computer system 100 for purchasing insurance in accordance with some embodiments of the disclosed technology. One or more server computers 104 include one or more programmed processors that execute instructions to send and receive information to a number of mobile devices 110a, 110b, 110c (collectively “mobile devices 110”). Each mobile device 110 can be a smart phone, tablet, or other portable computing device capable of running one or more applications (e.g. an “app”). A user can download the app from an app store, e.g. Apple iTunes (not shown). The app store can load a sequence of program instructions and other files onto the mobile devices 110 directly or onto another computer that in turn loads the app onto the mobile devices. When the app is run, a programmed processor within the mobile device 110 executes the instructions to present a number of user interface (UI) screens to the user in which the user can operate the mobile device 110 and information can be entered, displayed and passed back and forth between the mobile device 110 and the server computer 104 via a computer communication link.

In the insurance underwriting process, a consumer can use an application on his/her mobile device 110 (or computer) to apply for an insurance product. Using a camera, the application captures photographic information of identity assets such as a photograph of the applicant, a photograph of the applicant's driver's license or state-issued ID, and a primary form of payment, such as a credit card or debit card, and/or a selfie including the applicant's face. The application process can be completed without manually inputting (e.g., typing or keying) personally identifiable information because the application can use the photographic information to initialize the application process through one of the modules, such as an Insurance Application Module. In some embodiments, the application process can be completed in less than about ten minutes, 9 minutes, 8 minutes, 7 minutes, 6 minutes, or another suitable period of time. The systems and methods can reduce the consumer inputs and efforts required to apply for and receive an insurance policy. Depending on how the application process is tailored and/or adapted to individual applicants' identity, location, status, health condition, medical history, or other information collected during the process, the application process can provide UIs in different form, content, sequence, and/or quantity, to different applicants as part or the entirety of the insurance application process.

The server computer 104 can maintain a database 120 that stores records for a number of consumers. In one embodiment of the system, each consumer is identified by a unique identifier, such as their policy number, e-mail address, mobile phone number. The server computer 104 can include one or more modules 108, including a Validation Module, Automated Underwriting Review Module, Underwriting Acceptance Module, and so forth. Modules can include software, hardware, or firmware (or combination thereof) system, process or functionality, or component thereof, that performs or facilitates the processes, features, and/or functions described herein. In other embodiments. In some embodiments, individual mobile devices 110 can include one or more modules 108 for local processing. Each module 108 may include sub-modules. Software components of a module may be stored on a computer readable medium. Modules may be integral to one or more servers, or be loaded and executed by one or more servers. One or more modules may be grouped into an application, including an application on the mobile device.

The computing system 100 can include any number of clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

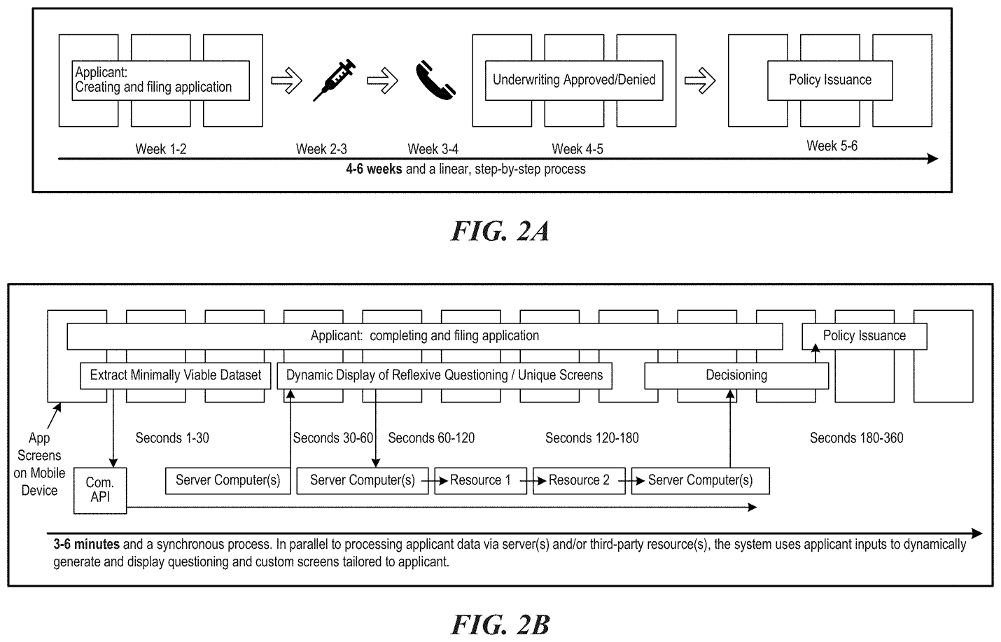

FIG. 2A illustrates a process for an applicant to apply for insurance (e.g., life insurance). The process can require traditional acts, such as requiring the applicant to fill out initial application paperwork, submit to a health exam (often including blood/urine sampling), and submit to additional screening (typically a phone interview). Traditionally the applicant would call or go online, wait for an insurance agent to be assigned, wait hours and often days until they get an agent to respond, then they would experience latency based on the availability and response rate of the agent. After multiple rounds of paperwork, exams, and/or screenings, the application is reviewed by an actuarial, before the application is accepted and policy issued. Traditional application processes are typically a linear and sequential process that takes 4-6 weeks.

FIG. 2B illustrates an example process for an applicant to apply for insurance (e.g., life insurance) in accordance with some embodiments of the presently disclosed technology. As illustrated, in a synchronous or parallel manner, the computer server(s) processes applicant data by communicating with third-party resource(s) (e.g., background check services, risk analysis services, other evaluation or analytical services related to applicant DNA, medical history, prescription records, etc.) while the mobile device keeps interacting with the applicant to receive additional input that may in turn be fed to the server side. This process enables on-the-fly generation and/or updating of reactive and/or reflexive user interfaces (e.g., screen displays) tailored to particular applicants.

For example, after the mobile application extracts a minimally viable dataset (e.g., applicant's name, date of birth, height, weight, and/or address) from the applicant via a first set of predetermined UI screens, the mobile application communicates the minimally viable dataset via one or more communication APIs to the server computer(s). The server computer(s) analyzes the minimally viable dataset with or without using third-party resources, and instructs the mobile application to generate and display UI screens with content (e.g., questions, notices, narratives, etc.) and/or formality (e.g., design, color, font size, etc.) that is determined based on the minimally viable dataset. The UI content and/or formality can be reflexive. Illustratively, the applicant's answer to and/or interaction with one question presented in the UI can change the format and/or substance of ensuing questions to be presented. For example, an answer “Yes” to a question “Do you drink alcohol?” can lead to display of questions such as “How many drinks do you consume per week?”, “Have you ever received treatment for your alcohol consumption?”, or the like. The reflexive aspect of the UI can be based on predetermined logic flow(s), newly acquired applicant data by the mobile device, and/or any response or information received from the synchronous or parallel data processing on the server side.

The mobile application interacts with the applicant via the dynamically generated and custom-tailored UI(s) to receive additional information from the applicant, which can be transmitted to the server computer(s) via the same or different communication API(s) for further analysis in parallel, which in turn can cause a new round of dynamic and custom-tailored UI generation and display. This synchronous or parallel process proceeds until a decision on the application can be made. This interactive, adaptive, and parallel process contracts or accelerates the entire application process (e.g., completing an application under 5 minutes), which allows for quoting and binding life insurance without, for example, health exams (or blood draws/urine samples). API-based communications (e.g., encrypted data over secure connections) among mobile device, server computer(s), and third-party resource(s) enable records-checking with third-party vendors that may be properly authorized to review data such as health history, prescription history, personally identifiable information, and other factors for decisioning.

In some embodiments, an Inquiry Module of the mobile device can send the minimally viable data set to the server(s) to determine whether additional data is needed. If the Inquiry Module receives a request for additional information, the Inquiry Module causes a GUI engine of the mobile device to generate UI(s) that are custom-tailored to the applicant based on the request. The user can input the additional information via the generated UI(s). The Inquiry Module can communicate the additional information to the server(s). This process can be repeated to generate a suitable set of data.

As discussed above, the GUI engine is configured to provide dynamically selected or generated UIs configured based on user inputted information, information from the server computer(s) via the same or different communication API(s), or the like. In some embodiments, the mobile application can communicate with multiple server computers to determine whether to request additional information from the user and/or whether record checking can be completed. In some embodiments, the mobile application can communicate, directly or indirectly (e.g., via a server computer), with multiple third-party resource(s) to enable complete records-checking even though a single vendor may not be able to provide a complete record check.

In some embodiments, if the mobile device does not receive a valid response (e.g., requiring additional data, providing an evaluation result, providing a progress status, etc.) from the server computer(s) within a threshold of time after transmitting data to thereto, the GUI engine can generate an alternative set of UI(s) for presenting to the applicant, which may retrieve an alternative set of information from the applicant as basis for at least part of the application process. In other words, depending on whether the synchronous or parallel processing at the server computer(s) is sufficiently efficient or timely, different UI(s) can be presented to an applicant for retrieval of information that constitutes different or alternative basis for at least certain parts of the application.

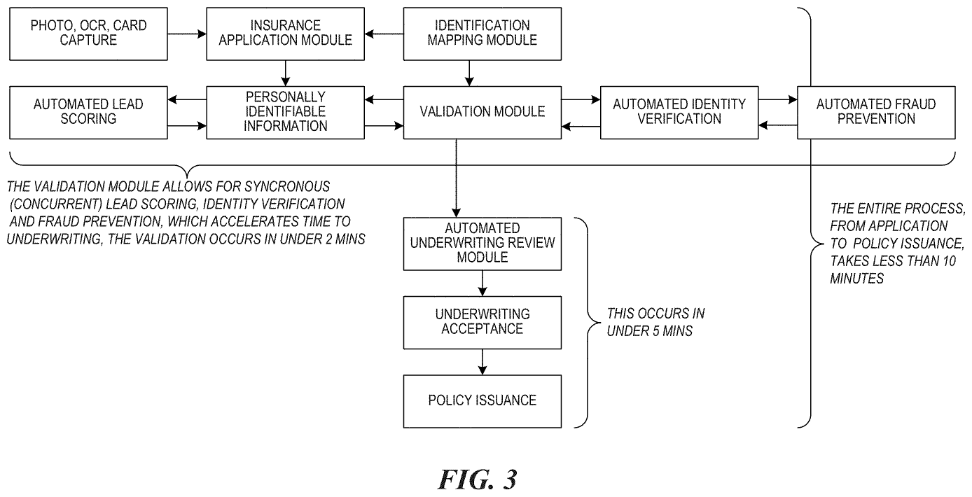

FIG. 3 is a flow diagram of steps performed by an insurance system in accordance with some embodiments of the disclosed technology. The system can perform each step to complete the application and underwriting process in a period of time (e.g., 5 minutes). Steps can be eliminated, reordered, or added to customize the process.

FIG. 3 shows an Insurance Application Module that can manage procedural aspects of the application process with a focus on multitasking key application functions. The Insurance Application Module can reside on a mobile device and include a rules engine and cache of information that meet the criteria of the insurance application process. The Insurance Application Module can serve as an automated control interface to the plurality of processes required to complete the application process. The Insurance Application Module can also include a database that manages stored/archived information that is generated during the application process, including Applicant data, as well as artificial intelligence (AI) for controlling the plurality of processes required to complete the application process.

An image of the driver's license or state-issued ID can be converted and passed through an Identification Mapping Module which results in a machine-readable object employing Eigenface and optical character recognition (OCR). Eigenvectors derived from images can map the face of the customer for identification purposes, and the OCR detection enables for pre-population of required fields for the application process. In some embodiments, the Identification Mapping Module includes a procedural rules engine governing the collection of information specifically relating to the capture of identity information and/or PII (personally identifiable information), which can constitute part or the entirety of the minimally viable data set to be analyzed by server computer(s) and/or third-party resource(s). The module can determine what information to collect and how to apply the information to the application process. Information can include name, date of birth, height, weight, address, and other variously available information from the Driver's License or state-issued ID. It can also force the request of manual inputs upon the applicant if incomplete information does not meet minimum requirements. For example, the Identification Mapping Module rules may determine insufficient information has been collected and alert the applicant to manually input information, such as a social security number. The Identification Mapping Module can also provide the rules for the collection of Eigenvector data which is typically collected from the Driver's License and compared against a picture (e.g., a Selfie) taken with the mobile camera. In this way, there is a collection process that maps the applicant to both a driver's license and the mobile device for which the application is occurring, and ensures that the facial characteristics of both photo assets are a match.

In some embodiments, the Eigenface, OCR, and/or other data-extraction features can be used synchronously (e.g., simultaneously) with applicant-data processing conducted locally at the mobile device and/or remotely at the server computer(s) with or without third-party resource(s). These include application factors such as: identity verification, fraud prevention, and lead scoring. Employing synchronous processing dramatically cuts down the time required for necessary identity, fraud and scoring activities. In some embodiments, the Validation Module can include a procedural rules engine governing the synchronous discovery, confirmation and collection of information about the applicant. This can include, but is not limited to, Fraud Prevention, Criminal History, identity verification, lead scoring, appended personally identifiable information not originally supplied by the applicant but discovered by analyzing previously supplied PII, etc. In addition, the Validation Module can communicate with an Automated Underwriting Review Module. The Validation Module communicates necessary PII and other information (e.g., Lead Score, Fraud Score, data records). The Validation Module combined with the Automated Underwriting Review Module results in an expedited acceptance or rejection of the application, and if acceptance, an ability to underwrite the policy at the proper pricing. The validation module can communicate (e.g., synchronously communicate) with multiple systems to build an “Applicant Container” on the applicant. In various embodiments, the communication can be for fraud prevention, lead scoring, or the like. The Validation Module Applicant Container stores the outcome of the synchronous discovery, which is stored as information, which can be passed to the Automated Underwriting Review Module.

The Automated Underwriting Review Module can include a determination rules engine governing the information suppliant and/or collected about the applicant. The Automated Underwriting Review Module can consume the Applicant Container which is supplied by the Validation Module. The Automated Underwriting Review Module uses an algorithm to analyze the Applicant Container against predetermined underwriting rules to make a final determination about the worthiness of the Applicant Container.

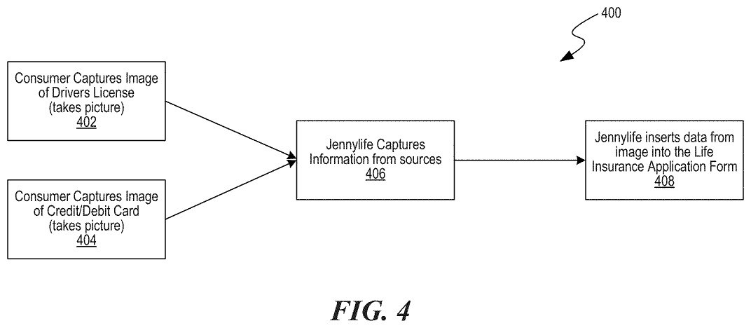

FIG. 4 is a flow chart of a method 400 for optical character recognition (OCR) technology used with driver license and credit card/debit card, in accordance with some embodiments of the presently disclosed technology. Generally, the mobile application (identified as Jenny Life) can allow for the capture of data and images from personal identification and payment cards to swiftly capture text from the consumer cards and insert them into insurance product application forms, GUI, or the like. This functionality minimizes, limits, or avoids the consumer having to type in multiple data fields and risk errors and friction of application completion.

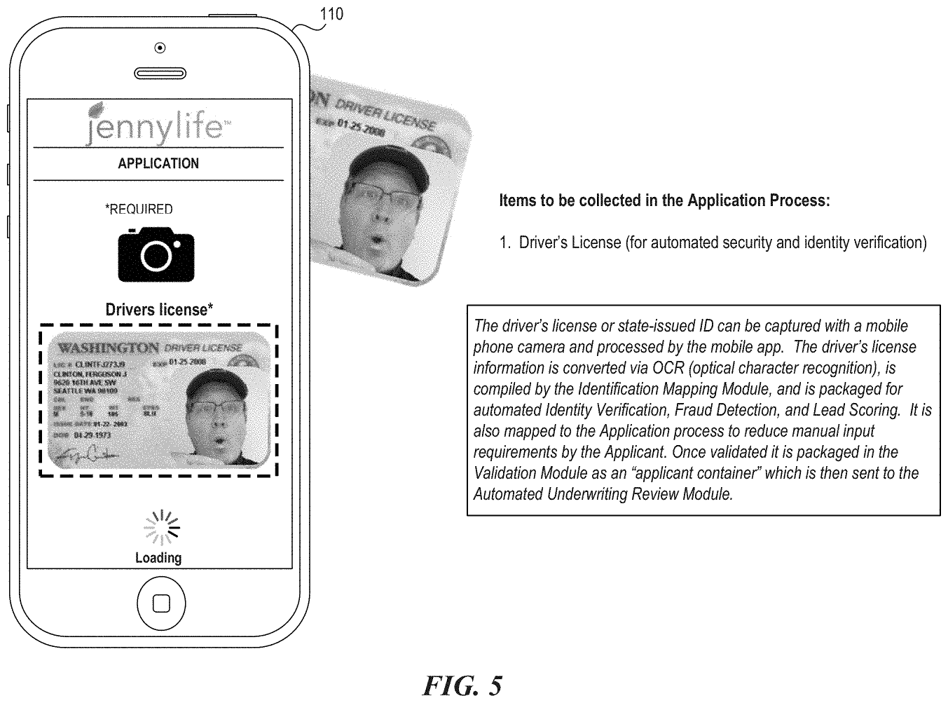

As illustrated in FIG. 4, at block 402, the mobile application prompts a consumer application to capture an image of his or her driver's license using the mobile device. The captured image typically includes the consumer's name, address, and photo. At block 404, the mobile application prompts the consumer to capture an image of a credit or debit card for payment. The capture image typically includes a card number, expiration date, and cardholder's name. At block 406, the mobile application extracts consumer data from the captured images. At block 408, the mobile application inserts the extracted data into insurance application form that the consumer is or will be interacting with. The consumer still has the option to updated/edit the fields that are populated with the OCR-enabled automatic data entry. Details of the method 400 are discussed in connection with FIGS. 5-9.

FIGS. 5-9 illustrate steps of an insurance application process in accordance with some embodiments of the presently disclosed technology. Referring to FIG. 5, an image of the driver's license or state-issued ID can be captured with a mobile phone camera and processed by the mobile app. The driver's license information is converted via OCR (optical character recognition), is compiled by the Identification Mapping Module, and is packaged for automated Identity Verification, Fraud Detection, and Lead Scoring. It can also be mapped to the Application process to reduce manual input requirements by the applicant. Once validated, it can be packaged in the Validation Module as an “Applicant Container” which is then sent to the Automated Underwriting Review Module.

Suitable smart phones, mobile or tablet devices can include cameras or optical sensors capable of capturing still images or video. For example, the smart phones can be Apple iPhones, Android phones, or other comparable phones from HTC, LG, Motorola, Samsung, Sanyo, Blackberry or other manufacturers. The mobile devices 110 may be portable computers (e.g., laptops or notebooks), personal digital assistants, tablet or slate computers (e.g. Apple iPad) or other devices which have the ability to send and receive information to the server computer via a cellular, wired or wireless (e.g. WiFi, WiMax etc.) communication link. In some implementations, a touch screen can be used to display information and to receive input from a user.

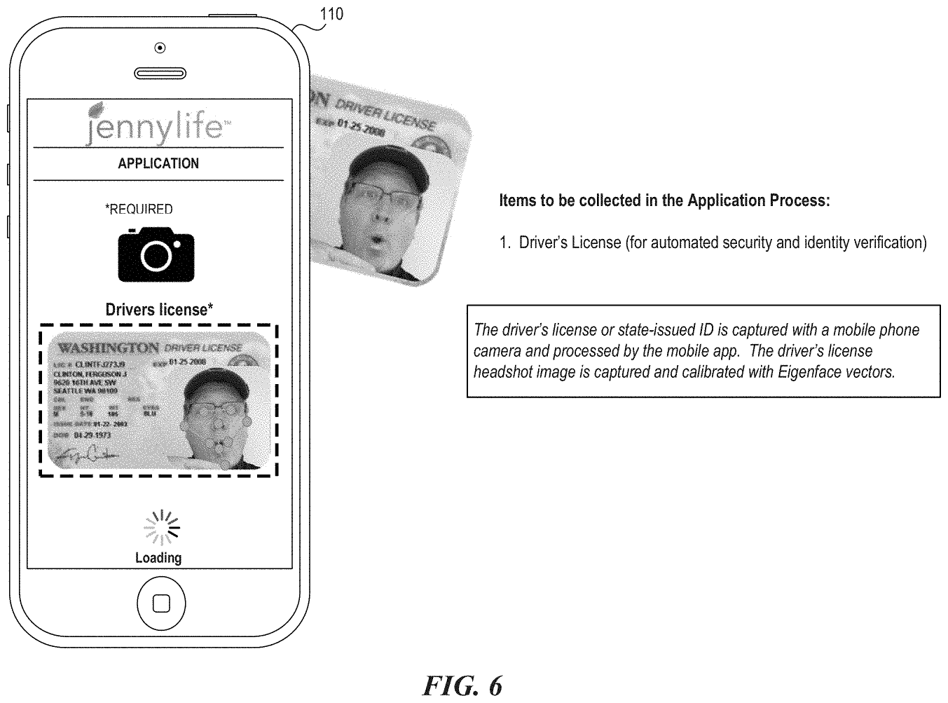

FIG. 6 shows the driver's license or state-issued ID is captured with a mobile phone camera and processed by the mobile app. The driver's license headshot image is captured and calibrated with Eigenface vectors.

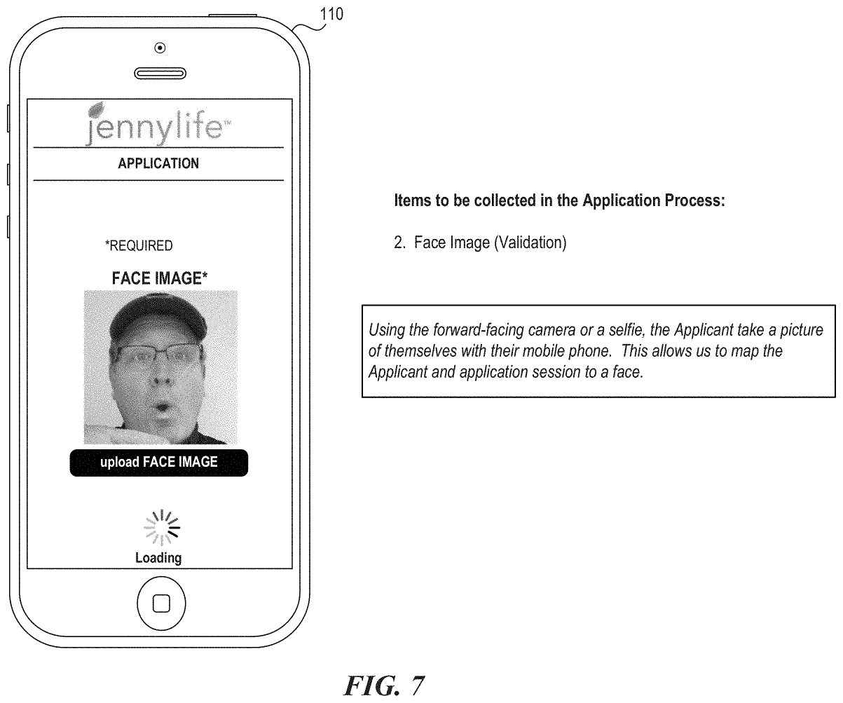

FIG. 7 shows face image validation in accordance with some embodiments of the presently disclosed technology. Using a forward-facing camera or a selfie, the Applicant can take a picture of themselves with their mobile phone. The system can map the Applicant and application session to a face included in the picture. In some embodiments, the system keeps a historical archive of all face and driver's license images that have been supplied so the information can be compared at any time. Doing so will help, especially with an issue like fraud. It is stored as an “Applicant Container” in the Insurance Application Module. Additional information can be stored in the “Applicant Container.”

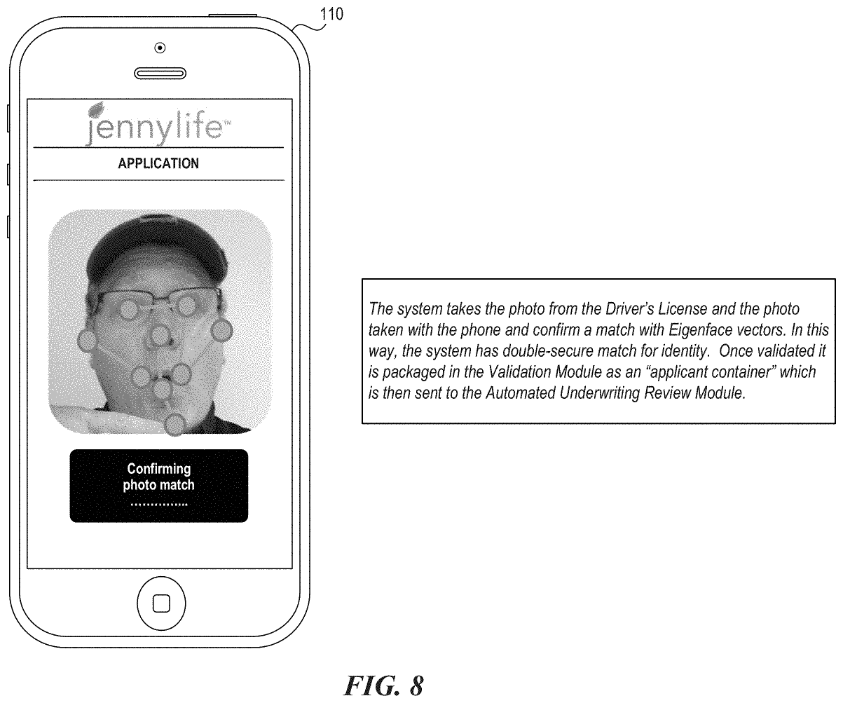

FIG. 8 shows the mobile device 110 analyzing an image in accordance with some embodiments of the presently disclosed technology. The system can take the photo from the Driver's License and the photo taken with the phone and confirm a match with Eigenface vectors. In this way, the system has double-secure match for identity. Once validated it is packaged in the Validation Module as an “Applicant Container” which is then sent to the Automated Underwriting Review Module. The analysis can be performed locally, remotely, or both. In locally analyzed embodiments, the analysis is performed by a processing unit of the device 110. In remotely analyzed embodiments, the analysis can be performed by a remote server or computing device.

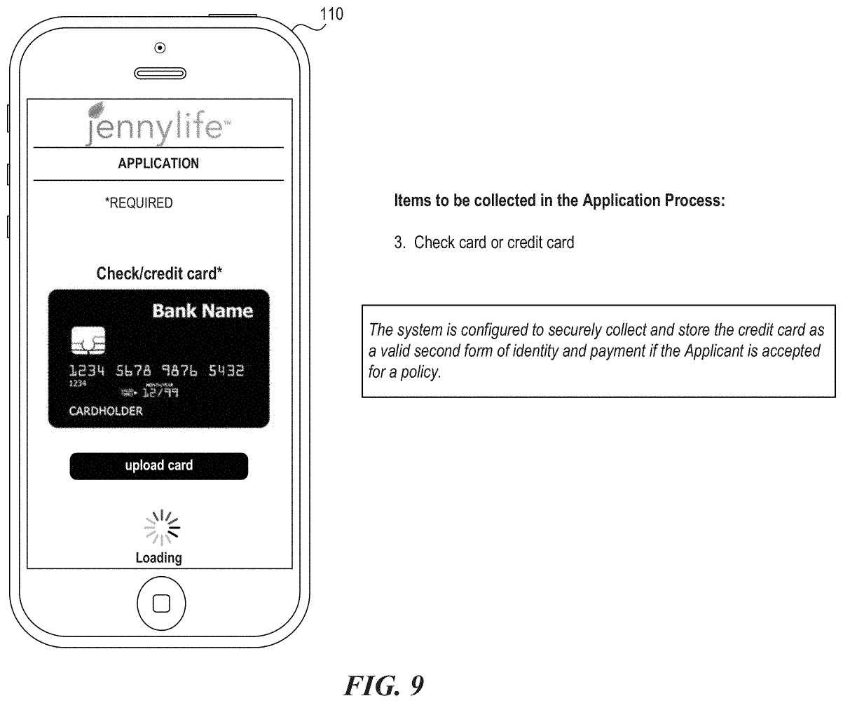

FIG. 9 shows information to be collected in accordance with some embodiments of the presently disclosed technology. The system is configured to securely collect and store the credit card as a valid second form of identity and payment if the Applicant is accepted for a policy. Other information can be collected and stored.

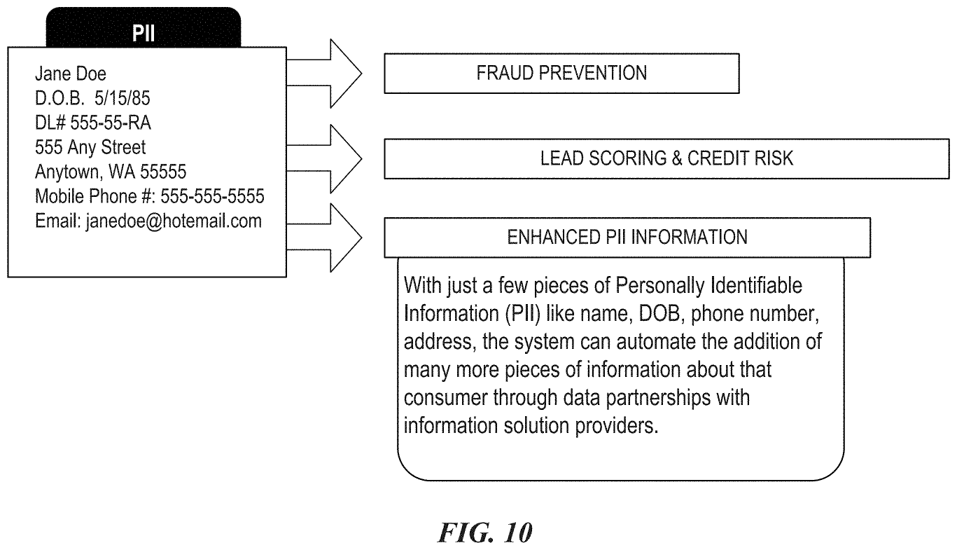

FIG. 10 is a flow chart for preventing fraud, lead scoring, evaluating credit risk, and enhancing PII information in accordance with some embodiments of the presently disclosed technology. The collected PII can be transmitted to third-party resources for record-checking, risk-analysis, information enhancement and supplementation, or other processing while the consumer interacts with the mobile application. In some embodiments, a user interface is provided to supplement information, correct information, view different policies (e.g., life insurance policies, disability insurance policies, etc.), review terms of policies, or the like.

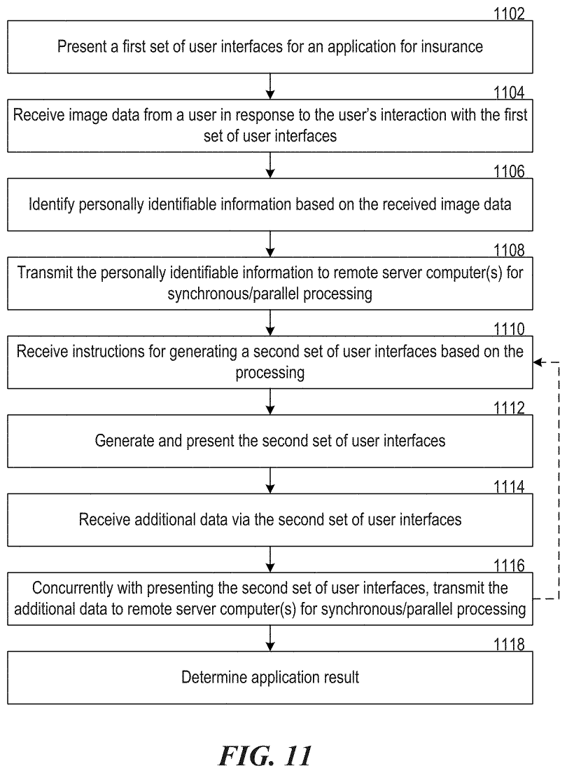

FIG. 11 is a flow chart of an example process for an interactive insurance application in accordance with some embodiments of the presently disclosed technology. At block 1102, a mobile device presents to a user a first set of user interfaces for an insurance application. At block 1104, the mobile device receives image data from the user in response to the user's interaction with the first set of user interfaces. At block 1106, the mobile device identifies personally identifiable information based, at least in part, on the received image data. In some embodiments, the identification can be achieved via communication with one or more server computers and/or third-party computing resources.

At block 1108, the mobile device transmits the personally identifiable information to at least one remote computing device (e.g., a server computer), where the personally identifiable information is processed and/or analyzed. In some embodiments, this is achieved based, at least in part, on communication between the remote computing device and one or more third-party computing resources. At block 1110, the mobile device receives one or more responses (e.g., instructions or requests) from the at least one remote computing device for generating a second set of user interfaces based, at least in part, on the processing or analysis of the personally identifiable information.

At block 1112, the mobile device generates and presents the second set of user interfaces. At block 1114, the mobile device receives additional data from the user in response to the user's interaction with the second set of user interfaces. At block 1116, concurrently with presenting the second set of user interfaces, the mobile device transmits at least a portion of the additional data to the at least one remote computing device, where the at least a portion of the additional data is processed and/or analyzed. In some embodiments, this is achieved based, at least in part, on communication between the remote computing device and one or more third-party computing resources.

If further data is needed for the application, the process proceeds back to block 1110, where the mobile device further receives one or more responses (e.g., instructions or requests) from the at least one remote computing device for generating another set of user interfaces based, at least in part, on the processing or analysis of the portion of the additional data. Otherwise, with or without an indication from the remote computing device, the mobile device can determine and provide a result for the application for insurance based on some or all of the information collected and/or prior communications with remote computing device(s).

Embodiments of the subject matter and the operations described in this specification can be implemented in digital electronic circuitry, or in computer software, firmware, or hardware, including the structures disclosed in this specification and their structural equivalents, or in combinations of one or more of them. For example, a mobile device or server computer (e.g., server computer 104 in FIG. 1) can perform OCR processing. Embodiments of the subject matter described in this specification can be implemented as one or more computer programs, i.e., one or more modules of computer program instructions, encoded on computer storage medium for execution by, or to control the operation of, data processing apparatus. For example, certain modules can be part of mobile applications installed on a mobile device, such as a tablet or smartphone, whereas other modules (e.g., Validation Module and Automated Underwriting Review Modules) can be installed on a server computer. Mobile devices can store, manage, and utilize the modules 108 discussed in connection with FIG. 1.

The server computers, mobile devices, and other electronic devices disclosed herein can include a computer storage medium configured to store data (e.g., consumer data), modules, etc. and can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium also can be, or can be included in, one or more separate physical components or media (e.g., multiple CDs, disks, or other storage devices). The operations described in this specification can be implemented as operations performed by a data processing apparatus on data stored on one or more computer-readable storage devices or received from other sources.

The server computers, mobiles devices, and other electronic devices disclosed herein can include data processing apparatuses. The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus also can include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

From the foregoing, it will be appreciated that specific embodiments of the invention have been described herein for purposes of illustration, but that various modifications may be made without deviating from the scope of the invention. For example, although the invention is described in terms of insurance application processes and underwriting, will be appreciated that the disclosed technology can be used with other types of application processes, information gathering systems, or the like. In addition, the technology can be adapted to other uses such as automobile insurance, mortgage insurance, medical insurance, lending, or other environments where customer/patient information gathering and analysis is desired. Accordingly, the invention is not to be limited except as by the appended claims.

What is claimed is:

1. A computer-implemented method performed by a portable computing device that is configured to communicate with at least one remote computing device, the method comprising:
presenting a first set of user interfaces for an application for insurance;
receiving image data from a user in response to the user's interaction with the first set of user interfaces;
identifying personally identifiable information based, at least in part, on the received image data;
transmitting the personally identifiable information to the at least one remote computing device, wherein the personally identifiable information is analyzed based, at least in part, on communication between the remote computing device and one or more third-party computing resources;
receiving instructions from the at least one remote computing device for generating a second set of user interfaces based, at least in part, on the analysis of the personally identifiable information;
generating and presenting the second set of user interfaces;
receiving additional data from the user in response to the user's interaction with the second set of user interfaces;
concurrently with presenting the second set of user interfaces, transmitting at least a portion of the additional data to the at least one remote computing device, wherein the at least a portion of the additional data is analyzed based, at least in part, on communication between the remote computing device and one or more third-party computing resources; and
providing a result for the application for insurance based, at least in part, on the analysis of the at least a portion of the additional data.

2. The computer-implemented method of claim 1, wherein the method is completed in a period of time equal to or shorter than 5 minutes.

3. The computer-implemented method of claim 1, wherein the first set of user interfaces are predefined independent of the personally identifiable information of the user.

4. The computer-implemented method of claim 1, wherein the image data includes at least one of an image of an identification card, an image of a payment card, or an image of the user's face.

5. The computer-implemented method of claim 1, wherein the method is completed without need for the user to manually type or key in textual information.

6. The computer-implemented method of claim 1, further comprising receiving instructions from the at least one remote computing device for generating a third set of user interfaces based, at least in part, on the analysis of the at least a portion of the additional data.

7. The computer-implemented method of claim 6, wherein providing a result for the application for insurance is further based on the user's interaction with the third set of user interfaces.

8. A non-transitory computer-readable medium storing content that, when executed by one or more processors, causes the one or more processors to perform actions comprising:
receiving image data from a user in response to the user's interaction with a first set of user interfaces for an insurance application,
identifying user-specific information based, at least in part, on the received image data;
transmitting the user-specific information to the at least one remote computing device for analysis;
receiving from the at least one remote computing device a first response to the transmitted user-specific information;
presenting a second set of user interfaces based, at least in part, on the first response;
receiving additional data from the user in response to the user's interaction with the second set of user interfaces;
concurrently with presenting the second set of user interfaces, transmitting at least a portion of the additional data to the at least one remote computing device for analysis; and
providing a result for the insurance application based, at least in part, on a second response to the transmitted at least a portion of the additional data.

9. The computer-readable medium of claim 8, wherein the second set of user interfaces are dynamically generated responsive to receiving the first response.

10. The computer-readable medium of claim 8, wherein content for the second set of user interfaces is generated, at least in part, by the at least one remote computing device.

11. The computer-readable medium of claim 8, wherein the actions further comprise causing matching a first image of the user's face with a second image data of the user's face.

12. The computer-readable medium of claim 11, wherein the first image is derived from an image of an identification card and the second image includes the user's face captured live by a mobile device

13. The computer-readable medium of claim 11, wherein the image data includes the first image and the additional data includes the second image.

14. The computer-readable medium of claim 8, wherein the actions further comprise presenting a third set of user interfaces based, at least in part, on the second response.

15. The computer-readable medium of claim 8, wherein the result of the insurance application includes at least one of approval, denial, or notice for further processing.

16. A system, comprising:
at least a memory storing computer-executable instructions; and
one or more processors that, when executing the instructions, are configured to:
receive image data from a user,
identify personally identifiable information based, at least in part, on the received image data,
cause first analysis of the personally identifiable information,
present one or more user interfaces based, at least in part, on the first analysis,
receive additional data from the user via the one or more user interfaces,
concurrently with presenting the one or more user interfaces, cause second analysis of at least a portion of the additional data and/or the personally identifiable information, and
determine a result for insurance application based, at least in part, on the second analysis.

17. The system of claim 16, wherein the system corresponds to a mobile phone or a server computer.

18. The system of claim 16, wherein the one or more processors are further configured to validate the identified personally identifiable information.

19. The system of claim 16, wherein the one or more processors are further configured to verify the user's identity based, at least in part, on the personally identifiable information.

20. The system of claim 16, wherein the one or more processors are further programmed to evaluate fraud risks based on the personally identifiable information.

21. The system of claim 16, wherein the one or more processors are further configured to automatically underwrite an insurance policy for the user based, at least in part, on data associated with the user.
